(19) United States
(12) Patent Application Publication
(10) Pub. No.: US 2009/0053380 A1
(43) Pub. Date: Feb. 26, 2009

(54) Method of reducing the spore content in a honey product and honey product obtainable by the method

(76) Inventor: Sven Hogh Petersen, Silkeborg (DK)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/666,758

(22) PCT Filed: Nov. 15, 2005
(86) PCT No.: PCT/DK05/00727

§ 371 Date: Oct. 8, 2008

(30) Foreign Application Priority Data
Nov. 15, 2004 (DK) PA 2004 01757

(51) Int. Cl. A23L 3/00; A23L 1/08

(52) U.S. Cl. 426/573; 426/521

(57) ABSTRACT

Method of reducing the spore content in a honey product and honey product obtainable by the method. By heat treatment of a honey product at high temperature for a very short time, a high degree of decimation is obtained without deterioration of the product.

### INTRODUCTION

The present invention relates to reduction of the risk of pathogenic anaerobic bacteria spores in a honey product by high-temperature, short-time heat treatment resulting in minimal changes in colour and taste. The minimal changes are indicated by the product's increase in HMF (HydroxyMethylFurfuraldehyde; see definition page 4) contents by no more than 15 mg/kg.

### BACKGROUND KNOWLEDGE

Honey is used by the industry and is consumed directly by many consumers. It is known that honey may contain Clostridium botulinum spores, probably picked up by bees. In many countries consumption of honey by infants less than one year old is discouraged because in infants C. botulinum is capable of colonizing in the intestine and start excreting toxin which makes the infant ill (infant botulism). The same probably applies to children more than 1 year old and to adults being treated with antibiotics or suffering from intestinal disorders.

Honey is widely used for wound-healing. In rare cases, Clotridium botulism could develop in the wound (wound botulism).

The complex of problems and the risk have been dealt with by the EU's Scientific Committee and are described in the publication “Honey and micro-biological Hazards” (adopted on 19-20 Jun. 2002). In this publication it is also written that there exists no process capable of eliminating spores in honey, and that selection of honey cannot take place by means of analysis because of the often low incidence of C. botulinum spores in honey. It is furthermore stated that existing practice for heat treatment of honey is effected at low temperatures (below 85° C.) at comparatively short holding times (approx. 10 seconds). This type of heat treatment has no reducing effect on the incidence of C. botulinum spores and other spores, but the purpose thereof is exclusively to melt crystals in the honey and possibly to prevent the growth of mould and fungi.

In heat treatment it is known that killing of Clostridium botulinum and other spores calls for temperatures over 110° C. and comparatively long holding times (more than 1 second). According to Food microbiology (Adams & Moss), C. sporogenes spores have a decimation time at 121° C. (D₁₂₁) of 0.1-1.5 minutes, and C. botulinum spores types A & B a D₁₂₁ of 0.1-0.2 minutes. Because C. sporogenes is not pathogenic and has a morphology very much resembling that of C. botulinum as well as a somewhat higher heat resistance, it is a suitable test organism for the evaluation of kill of C. botulinum. It is generally known that it is used for this purpose in the processing industry.

It is also known in respect of honey that at a heat treatment over 110° C. and comparatively long holding times (more than 1 second), the taste and colour of the honey change considerably. HMF (HydroxyMethylFurfuraldehyde) is used as an indicator of heat influence and storage changes in honey. By heat treatment of honey at temperatures over 110° C. and more than 1 second, the HMF content will be increased by more than 15 mg of HMF per kg, and taste and colour change. considerably (malt like taste and darkening).

### Definitions:

Honey is defined more specifically in EU Council Directive 2001/110/EC of 20 Dec. 2001, enclosure II.

Many general definitions used in connection with honey are found in the Honey Directive.

Honey products are taken to mean products comprising honey, Royal Jelly, Propolis and/or Propolis extract.

### Honey:

Honey is taken to mean the natural sweet substance produced by Apis mellifera bees from the nectar of plants, or from secretions of living parts of plants or excretions of plant sucking insects on the living parts of plants, which the bees collect, transform by combining with specific substances of their own, store and leave to ripen in honey combs.

### Royal Jelly:

Secretion secreted from glands on the top of the heads of young bees, which is used as feed for bee larvae in the first 2-3 days of the larval stage and which is given as the only feed to queen bee larvae throughout the entire larval stage. The secretion has a high content of proteins, lipids, glycosides, vitamins, hormones, enzymes and minerals.

### Propolis:

Propolis is taken to mean a resin-based raw natural product processed by honey bees, which contains a number of biologically active components chemically consisting i.a. of terpens, cinnamic acid, caffeic acid, and their esters, amino acids and flavonoids.

### Propolis Extract:

Components of Propolis extracted with water or alcohol.

HMF stands for 5-hydroxymethylfurfural. The HMF value is stated in mg/kg of honey and is a measure of darkening of the honey, i.a. due to heat treatment. It is determined in accordance with DIN 10751/1.

Honey used in a product intended-for human consumption should i.a. generally have a water content of at the most 20%, and the HMF content must at the most be 40 mg/kg.

Decimation value is a measure of the number of decimations. For example, a decimation value of 2 is a reduction in number of 99%, and a decimation value of 3 is a reduction in number of 99.9%.

Decimation time is the time at a particular temperature to reduce the viable population by 90% or 1 log.

Spore is a resistant body formed by certain microorganisms that can grow as a vegetable cell.

Anaerobic spores are spores that can grow as vegetable cells in the absence of molecular oxygen. They are determined by the method DRCM, 5d, 37° C.

Spore free is a product where the level of spores is max 1 cfu/g.

Naturally occurring anaerobic spores in honey is the number of anaerobic spores that could possibly be present in honey according to the data mentioned in the EU publication: “Honey and microbiological Hazards” (adopted on 19-20 Jun. 2002). It is considered to be maximum 10 000 cfu/g.

### BRIEF MENTION OF THE INVENTION

It has now surprisingly been found that by heat treatment of honey at temperatures over 110° C. with holding times below 1 second, it is possible to obtain a considerable spore kill, with minimal changes in the colour, taste and HMF content of the honey. It has thus been accomplished to reduce the number of anaerobic spores (C. sporogenes) added to honey from 1 to 8 log by heat treatment at temperatures of 110-140° C. Hereby a method has been provided which is capable of reducing naturally occurring anaerobic spores in lo honey and thereby to eliminate the risk of developing infant botulism by intake of a reasonable amount of honey as regards children younger than 2 years. Furthermore, the honey is useful for wound care with no risk of developing wound botulism. The method is also useful for the treatment of other secretions from bees (Propolis and Royal Jelly) or extracts and syrup prepared hereof. It is well known that spores can be reduced with temperatures above 110° C. and holding times of several seconds or minutes but this will result in severe changes in the taste and colour of the honey product and an increase in the HMF contents by more than 15 mg/kg. Due to the very short holding time, our product has kept its natural colour and taste indicated by the small increase in HMF of max 15 mg/kg.

### BRIEF DESCRIPTION OF THE DRAWINGS

FIG. 1 is a sketch of a UHT plant

FIG. 2 shows formation of HMF (mg/kg)

FIG. 3 shows spore kill in honey

### DETAILED DESCRIPTION OF THE INVENTION

It is the object of the present invention to provide:
A heat treated honey product free from naturally occurring anaerobic spores with an HMF content below 40 mg/kg.
Such a honey product in the form of bee honey or syrup thereof.
Such a honey product in the form of Propolis or syrup thereof.
Such a honey product in the form of Royal Jelly or syrup thereof.
A process where, in liquid bee honey and other honey products, considerably shorter decimation times are obtained for anaerobic spores than what is known from literature by heat treatment at temperatures over 110° C. and holding times below 1 second.
Treatment of honey where all naturally occurring spores can be eliminated (reduced) by heat treatment with maximum increase in the HMF content of 15 mg/kg and with minimal impact on colour, smell and taste.
Heat treatment of honey at temperatures over 110° C. and holding times below 1 second, where after the treatment HMF is below 40 mg/kg, as much as down to an increase of at the most 15 mg/kg relatively to the level in the honey before heat treatment.
Heat treatment of syrup with added honey or other products from bees (Royal Jelly, Propolis etc.) or extracts hereof at temperatures over 110° C. and holding times below 1 second with the object of reducing the number of anaerobic spores and preserving taste and physico-chemical properties better than by conventionally used heat treatment.

The invention therefore relates to a method of significantly reducing or eliminating the naturally occurring content of Clostridium botulinum spores in a honey product by heat treating it at 110° C.-170° C. for 0.001 second to 1 second, i.e. 1-1000 ms, so that the HMF content is not significantly increased.

A not significant increase in the HMF content is taken to mean an increase of at the most 15 mg/kg when using the honey for consumption purposes. In the directive, honey for non industrial or bakery use must maximum contain 40 mg/kg of HMF.

Thereby it is possible to prepare a spore free honey product with an HMF content below 40 mg/kg.

A significant reduction or elimination is taken to mean a decimation of 1-8 (log 1 to log 8 cfu/gram), i.e. log 1, log 2, log 3, log 4, log 5, log 6, log 7 or log 8.

The honey product used in the treatment may have been subjected to a general pre-treatment, for example filtration or heat treatment at a lower temperature.

### Treatment Temperature

Useful temperatures are 115° C., 120° C., 125° C., 130° C., 135° C., 140° C., 145° C., 150° C., 155° C., 160° C., 165° C. or 170° C. If lower temperatures are used no, or an inferior, spore reduction is achieved by the short treatment time. It is possible to use even higher temperatures, but then the risk of deterioration is higher as regards discolouration, taste, and the HMF content.

### Heat Treatment Time, Also Called Holding Time

The heat treatment time is approx. from 1 ms to approx. 1000 ms. Particularly advantageous holding times are 1 ms; 2 ms; 3 ms; 4 ms; 5 ms; 6 ms; 7 ms; 8 ms; 9 ms; or 10 ms; but also longer holding times of 20 ms; 30 ms; 40 ms; 50 ms; 60 ms; 70 ms; 80 ms; 90 ms or 100 ms are useful. Also holding times of up to approx. 1000 ms can be used, for example 900 ms; 800 ms; 700 ms; 600 ms; 500 ms; 400 ms; 300 ms or 200 ms.

Of course, treatment at a high temperature for a short time is aimed at.

The currently preferred treatment is a temperature of 130° C. for 0.01 second.

The treatment may be effected in a plant capable of heat treating products at temperatures over 100° C. and at holding times from 2-1000 ms. The plant may operate according to the infusion principle or by vapour injection, steam injection. Commercial plants of this kind are available from companies such as Niro, GEA, APV and Tetra Laval. It is not entirely easy to determine the holding times, which are determined on the basis of a number of physical conditions in the plant, including the size of the holding cell and vapour pressure and valve position and physical vapour data, in accordance with principles which are apparent from for example Niro's EP application EP 1047303A2: ULTRA-SHORT HEAT TREATMENT METHOD FOR A LIQUID.

The invention also relates to a honey product obtainable by the method as described.

Bee honey is obtainable with an HMF content (mg/kg) below 40, 39, 38, 37, 36, 35, 34, 33, 32, 31, 30, 29, 28, 27, 26, 25, 24, 23, 22, 21,20, or even lower values, depending on the HMF content of the starting materials, and a decimation value of from 1 log to 8 log, including also 2 log, 3 log, 4 log, 5 log, 6 log and 7 log. The results obtained are shown in the following. At the same time it is possible to obtain a minimal increase in the water content of below 3%. It is not inconceivable for even lower HMF contents (mg/kg) to be obtained by e.g. treating new-extracted honey, for example 20, 19, 18, 17, 16, 15, 14, 13, 12, 11, 10, 9, 8, 7, 6, 5.

It is hard to tell how low it is possible to get since an increase takes place in the HMF content which the honey already has. An increase of up to 15 mg/kg and a content of up to 40 mg/kg are therefore acceptable. The aim is to have minimal increase and minimal HMF content in the finished honey. An optimization of the preheating time is to be made prior to heat treatment according to the invention, for example in an LSI-plant (see below). It is to be expected that it is possible to get down to a maximum increase in the HMF content of 14 mg/kg, 13 mg/kg, 12 mg/kg, 11 mg/kg, 10 mg/kg, 9 mg/kg, 8 mg/kg, 7 mg/kg, 6 mg/kg, 5 mg/kg, 4 mg/kg, 3 mg/kg, 2 mg/kg. As point of departure, the honey used in the experiments had an HMF content of 28 mg/kg, as in advance it has been subjected to a common, light heat treatment (molten with 70° C. hot air and heated to 54° C. before filtration) at the supplier's in order to melt possible crystals. If new-extracted honey is used, the HMF content is presumably as low as 1-5 mg/kg. The natural content may vary from honey type to honey type.

### Experimental Part

The following methods of determination have been used:

### Reduction (Kill) of Anaerobic Spores:

Reduction of anaerobic spores was evaluated by adding a suitable anaerobic spore and determining the level of spores before and after heat treatment. As regards morphology, substance conversion and heat resistance, C. Sporogenes very much resembles C. Botulinum. We use this organism because it is not pathogenic and is therefore often used as test organism and substitute for C. Botulinum. Seeding is performed with C. Sporogenes in about 1 litre of growth medium. The medium is placed at 37° C., and the bacteria multiply under anaerobic conditions. When there is no more nutrition present and the growth stops, the medium is cooled. In that connection the vegetative cells will assume spore form. The spore content is determined by microscopic counting and by culturing in accordance with the plate scattering method. Addition of minimum 1×10⁵ cfu/g to the honey is aimed at. It is important to obtain a high concentration of spores in the spore suspension in order to avoid too much dilution of the honey.

The spore suspension is filled into 3×1 litres laboratory bottles with screw cap, so-called bluecaps. These bluecaps are stored cool upon receipt. Immediately prior to run, the spore solution is added to the preheated honey under stirring, and stirring is performed carefully. It is not expected that the spores will sediment in the honey in the balance tank of an LSI plant (see the following) because of the high viscosity and the short retention time. The osmotic pressure in the honey will ensure against incipient germination which would otherwise reduce the heat resistance of the spores.

### Determination of the Spore Content

The analysis is set up in accordance with the MPN (most probable number) method and examines for aerobic and anaerobic spores from bacteria of the genus bacillus and Clostridium. The methodology is OXOID-Crossley milk. MPN method. Use is made of Oxoid-Crossley milk medium—Oxoid 0213. The samples are heat treated for 20 minutes at 80° C. to kill vegetative cells and activate the formation of spores. Serial dilutions are prepared in accordance with the MPN principle, and seeding is performed in 3 rows with 3 tubes with 1 ml of sample (or dilution). The samples are incubated for 4 days at 37° C. in heating cabinet. The samples are read and are deemed positive if the colour of the medium has changed to purple.

### Heat Treatment-Temperature:

The heat treatment temperature was determined by a Frode Pedersen Termoelement type K, No. 061901-1 with earthed welding spot supplied by Ametek Denmark A/S.

### Holding Time:

The treatment time, which is called holding time or retention time, was calculated from the volume of the holding cell and the product flow and calculations of the vapour level used. The vapour level was calculated from pressure determinations over a reduction valve and the characteristics of the valve. The pressure loss was determined on 2 calibrated digital manometers. The product flow was determined by means of a magnetic flowmeter. These data were collected continuously by means of data logs. The method is, in particular as regards small plants, associated with some uncertainty, but all holding times are estimated to be below 1 second. For large plants, an accurate vapour meter can be used, which increases the accuracy of the calculated holding times. The calculated values were, however, used for determining kill kinetics for the spores.

### Determination of HMF

The analyses were made externally at the Honninginstituttet Dr. C. Lüllmann, Bremen. The method is in accordance with DIN 10751, part 1, and is designated Winkler and employs p-toluidine and photometric determination.

### Heat Treatment Equipment:

The UHT-treatment was performed on a pilot UHT-plant with direct vapour injection designated LSI. LSI-plants is a trademark of the company Niro A/S (now GEA), Gladsaxevej 305, Soborg, Denmark, but there are other commercially available plants capable of heat treatment with short holding times (below 2 seconds), for example Instant Infusion from the company Ivensys APV. The plant employed has a capacity of 100 kg/hour. The plant is designed to operate with extremely low holding time, below 1 second, at temperatures over 100° C. This is done by supplying excess vapour which very quickly expels the product from the holding cell. The plant is provided with data logs, and major operational data can be calculated from thermo-dynamic calculations.

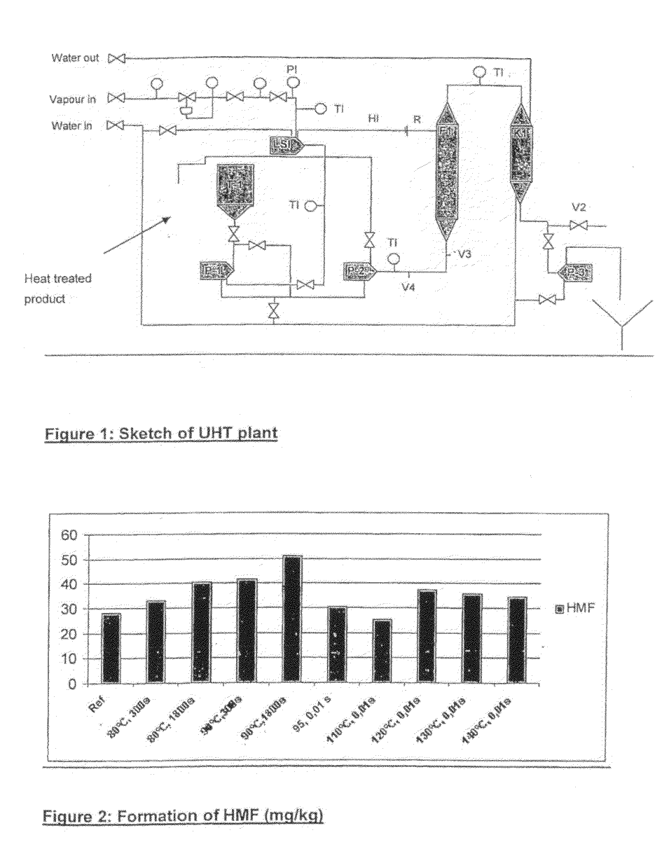

A sketch of the UHT plant is shown in FIG. 1 The symbols in the figure have the following meaning:
T1=Feed tank. F1=Flash tank. K1=Condenser. PI=Manometer. TI=Thermometer
P1=Feed pump
P-2=Withdrawal pump. P-3=Vacuum pump. LSI=LSI unit. R=Orifice. V1=Vapour reduction valve
V2=Snifting valve. V3=Sampling rubber membrane. V4=Sampling tap. HI=Holding cell
   Operation of LSI is described in the accompanying documentation from Niro A/S. The process can be carried out in corresponding UHT plants from other manufacturers.

### EXAMPLES

### Spore Reduction in Honey

Seeding is done with C. Sporogenes in approx 1 litre of growth medium. The medium is positioned at 37° C., and the bacteria proliferate under anaerobic conditions. When there is no more nutrition present and the growth stops, the medium is cooled. In that connection the vegetative cells will assume spore form. The spore content is-determined by microscopic counting and by culturing in accordance with the plate scattering method. Addition of minimum 1×10⁵ cfu/g to the honey is aimed at. It is important to obtain a high concentration of spores in the suspension to avoid too much dilution of the honey.

The spore suspension is filled onto 3×1 litres bluecaps. These bluecaps are stored cool upon receipt.

45 kg of honey are stored in a tank with heating jacket to 50° C. It is important for the water temperature in the jacket not to exceed 55° C. as the HMP content could increase if the temperature gets too high or the heating time too long. Hereafter 3 litres of C. sporogenes suspension are added. Careful stirring is performed. A sample of the honey with spores is taken for analysis. The LSI plant is started on water and set to a LSI temperature of 140° C. and a flash vapour temperature of 55° C. When the plant is running stably the water level in the feed tank is allowed to drop completely, and the honey containing the spore suspension is added. The honey is heated in the plant to a temperature of 140° C. and held at this temperature for less than 1 second, and is flash-cooled to 55° C. Samples of the honey are taken after the flash-cooling when the plant is running stably.

The samples before and after heat treatment are analyzed for S. Sporogenes and HMF.

The experiment can be repeated at other temperatures, for example 150, 130, 120 and 110° C.

### Spore Reduction in Royal Jelly Syrup

30 kg of syrup are prepared by weighing out 9 kg of water and heating it to 55° C. in water bath. Hereafter 18 kg of fructose are added which are dissolved in the water. The solution is added with 3 kg of freeze-dried Royal Jelly. The Royal Jelly syrup is added to the spore suspension and treated on LSI analogously with the honey. Samples are likewise taken before and after LSI treatment.

### Spore Reduction in Propolis Syrup

30 kg of syrup are prepared by weighing out 9 kg of water and heating it to 55° C. in water bath. Hereafter 18 kg of fructose are added which are dissolved in the water. The solution is added with 3 kg of freeze-dried Propolis extract from Prophararma (PWE-13). The Propolis syrup is added to the spore suspension and treated on LSI analogously with the honey. Samples are likewise taken before and after LSI treatment.

By use of approx. 60%, of fructose syrup, a self-preserving effect is obtained as yeast and bacteria are not able to grow at the high osmotic pressure. By use of fructose, crystallization is furthermore avoided. If the product surface atmosphere is an inert gas, such as for example nitrogen or carbon dioxide, you can store your product in a safe way since growth of bacteria, yeast and mould is thus prevented.

### Results

By use of the general method described above, the following results were obtained.

TABLE 2
Determinations of honey:

| | | | Measured | | | |
|---|---|---|---|---|---|---|
| | | Holding | temp min- | Product | Product | |
| Experi- | Temp | time | max | in | out | HMF |
| ment | ° C. | Sec. | ° C. | ° C. | ° C. | mg/kg |
| Reference | 0 | 0 | 0 | 0 | 0 | 28 |
| 1.1 | 80 | 300 | 79-81 | | | 33.0 |
| 1.1 a | 80 | 1800 | 79-81 | | | 40.7 |
| 1.2 a | 90 | 300 | 89-91 | | | 41.6 |
| 1.2 | 90 | 1800 | 89-91 | | | 51.0 |
| 1.4 | 95 | 1 | 94-96 | 45 | 57 | 30.5 |
| 1.5 | 110 | 0.01 | 109-110 | 42 | 62 | 25.3 |
| 1.6 | 120 | 0.01 | 120-124 | 55 | 49 | 37.5 |
| 1.7 | 130 | 0.01 | 129-132 | 50 | 63 | 35.8 |
| 1.8 | 140 | 0.01 | 141-142 | 49 | 63 | 34.7 |

Formation of HMF (mg/kg) as compared with temperature and holding time is shown in FIG. 2. Samples with holding time higher than 1 second are prepared by heating in water bath where the temperature is held for the stated number of minutes.

The LSI treatment increases the HMF content by up to 10 HMF mg/kg at temp. 120° C.-140° C. At 110° C. is seems that the HMF content is unaffected.

Heating to 80° C. and 90° C. seems to considerably increase the HMF contents because of the long holding time. At 80° C. and 90° for 300 and 1800 seconds holding time there was not measured any reduction of spores (results are not shown).

For LSI-treated honey it seems to be no problem to observe the Directive concerning honey's standard for HMF content of at the most 40 mg/kg.

TABLE 3
Results and calculations of spores from experiments

| | | | Calculated | | | |
|---|---|---|---|---|---|---|
| Sample | | MPN- | Holding | | | |
| Id. | | spores | time | | Dt | |
| No. | Process | (cfu/ml) | (min) | Log-MPN | (min) | Log Dt |
| 163876 | Reference | 96.000.000 | 0 | 7.982 | | |
| 163877 | Reference | 96.000.000 | 0 | 7.982 | | |
| 163888 | 95° C. - 1s | 1.100.000 | 0.01667 | 6.041 | 0.00859 | −2.066 |
| 163889 | 95° C. - 1s | 1.100.000 | 0.01667 | 6.041 | 0.00859 | −2.066 |
| 163868 | 110° C. - 0.01s | 11.000.000 | 0.00017 | 7.041 | 1.77*10E-4 | −3.752 |
| 163869 | 110° C. - 0.01s | 11.000.000 | 0.00017 | 7.041 | 1.77*10E-4 | −3.752 |
| 163870 | 120° C. - 0.01s | 11.00.000 | 0.00017 | 6.041 | 8.59*10E-5 | −4.066 |
| 163871 | 120° C. - 0.01s | 1.100.00 | 0.00017 | 6.041 | 8.59*10E-5 | −4.066 |
| 163872 | 130° C. - 0.01s | 3.6 | 0.00017 | 0.556 | 2.24*10E-5 | −4.649 |
| 163873 | 130° C. - 0.01s | 3.6 | 0.00017 | 0.556 | 2.24*10E-5 | −4.649 |
| 163874 | 140° C. - 0.01s | 1 | 0.00017 | 0.000 | 2.09*10E-5 | −4.680 |
| 163875 | 140° C. - 0.01s | 1 | 0.00017 | 0.000 | 2.09*10E-5 | −4.680 |

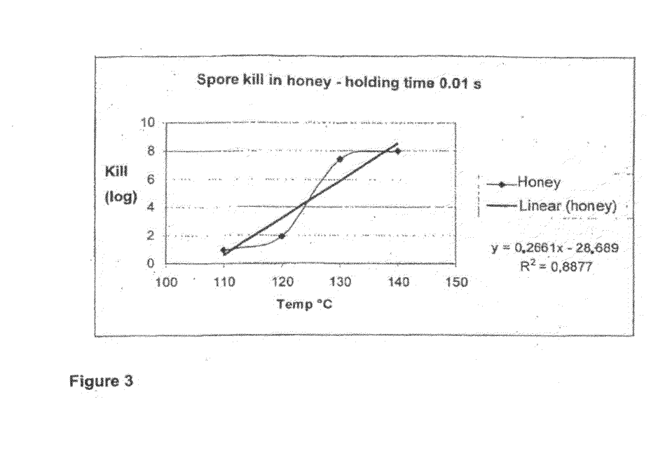

FIG. 3 shows the obtained results graphically.

### CONCLUSION

As is apparent from FIG. 3, it is possible by the method according to the invention to obtain a very efficient reduction of C. sporogenes spores at a calculated holding time of less than 1 second. Already at 110° C. do we obtain a reduction of approx 1 log increasing to 8 log's reduction at 140° C. This efficient kill yields good Dₜ values (Decimation times). According to literature, C. sporogenes has D₁₂₁ of between 0.1-1.5 minutes, typically of 1 minute. By the method, a D₁₂₁ value of 8.59*10⁻⁵ minutes is surprisingly obtained at 120° C., i.e. a 11000-12000 times shorter kill time than the table value. It is not possible to currently explain the reason for this huge effect, but the momentary heating and cooling could possibly have some kind of chock effect which gives significantly higher kill than traditional heat treatment (longer time).

Kill curves, D₁₂₁, Dₜ values, are described frequently in literature, for example Pelczar, Reid, and Chan Microbiology, 1977 or Poul Erner Andersen & Jorgen Risum “Indtroduktion til levnedsmiddel teknologien”, 1989.

The HMF content is increased during heating, but less at UHT treatment than at prolonged heating at low temperature. Thus it has been succeeded to observe the Directive's standard of maximum 40 mg of HMF per kg at UHT treatment of honey.

1-4. (canceled)

5. A method of preparing a heat treated honey product under significant reduction or elimination of the naturally occurring content of Clostridium botulinum spores in a natural honey product by heat treating it at 100° C.-170° C. with a holding time of between 0.001 second and 1 second, without the HMF level being increased by more than 15 mg of HMF per kg, and the HMF-content in the treated product is below 40 mg of HMF per kg.

6. A method according to claim 5, wherein a honey product is heat treated at 110° C.-140 C for 0.001 second to 1 second.

7. A method according to claim 5, wherein a honey product is heat treated at at least 120° C.-130° C. for 0.001 second to 1 second.

8. A method according to claim 5, wherein a honey product is heat treated at at least 125° C. for 0.1 second.

9. A method according to claim 5, wherein a honey product is heat treated at at least 130° C. for 0.01 second.

10. A method according to any one of claims 5 to 9, wherein the honey product is bee honey or syrup thereof.

11-12. (canceled)

13. A method according to any one of claims 5 to 9, wherein the method is carried out in a UHT plant.

14. A heat treated honey product obtainable by the method according to any one of claims 5 to 9.

15. (canceled)
